(19) United States
(12) Patent Application Publication
(10) Pub. No.: US 2011/0101970 A1
(43) Pub. Date: May 5, 2011

(54) POSITION SIGNALING DEVICE

(75) Inventor: Joshua LANTER, Chur (CH)

(73) Assignee: POLYCONTACT AG, Chur (CH)

(21) Appl. No.: 12/939,616

(22) Filed: Nov. 4, 2010

(30) Foreign Application Priority Data
Nov. 5, 2009 (CH) 1702/09

(51) Int. Cl. G01B 7/30

(52) U.S. Cl. 324/207.25

(57) ABSTRACT

A position signaling device is disclosed for detecting a position of two metallic or metal-coated components that can move relative to one another. the device can include a magnetic field-sensitive sensor and at least one bias magnet that are spatially separated from one another and are arranged in a stationary manner relative to one another. The magnetic field-sensitive sensor and the bias magnet on two sides border a receiving gap in which one of the two components can be moved relative to the other. The magnetic field-sensitive sensor and the bias magnet are connected to one of the two components. In a vicinity of the magnetic field-sensitive sensor and/or of at least one bias magnet, at least one flux concentrator is arranged such that a largely closed magnetic circuit is formed.

### RELATED APPLICATION

This application claims priority under 35 U.S.C. §119 to Swiss Patent Application No. 1702/09 filed in Switzerland on Nov. 5, 2009, the entire content of which is hereby incorporated by reference in its entirety.

### FIELD

The disclosure relates to a position signaling device.

### BACKGROUND INFORMATION

In many applications, the position of a metallic or metal-coated component whose location can be changed is determined. For example, motor vehicles, especially passenger cars, are being increasingly equipped with safety devices such as front, side and head airbags. These safety devices are designed to protect passengers in the event of a collision and to reduce the risk of injury. Airbags can be deployed and inflated within a very short time interval. For this purpose, propellant charges can be used that explosively fill the airbag and that allow it to emerge from the respective lining. The arrangement of the airbags and the selection of their size represent a compromise that is to be matched to the different sizes and different weights of the vehicle passengers. For some front airbags, the airbag can be inflated to different degrees depending on the seat position of the passengers. Thus, for a large passenger whose seat is correspondingly arranged farther away from the dashboard, the airbag can be inflated more greatly than in the case of a smaller passenger whose seat has been pushed into a position nearer the dashboard. This is intended to prevent a passenger nearer the dashboard from being injured by the kinetic energy of an airbag that has been inflated with full energy. The inflation energy of the airbag is accordingly controlled by way of staggered amounts of the propellant charge that are ignited. Therefore, knowledge of the distance of the vehicle seat from the dashboard is useful for controlling the inflation energy for the airbag.

Therefore, in the past, different mechanical and electromechanical devices have been used to determine the position of the vehicle seat. Mechanical and electromechanical position signaling devices are, however, relatively susceptible to wear and can lead to unpleasant, unwanted noise in the adjustment of the vehicle seat. In the course of increasing automation, motor vehicles are being equipped more and more with electrical and electronic components that assume the function of earlier mechanical and electromechanical detector devices. Thus, there are known contactless detector devices with which the relative position of two components that can be moved toward one another can be detected in order to generate a corresponding control signal. In the case of the vehicle seat, the components that can move relative to one another can be, for example, mounting rails that are mounted on the vehicle floor and a seat rail that is permanently connected to the vehicle seat. In order to be able to ascertain the relative position of the two rails, for example, on the mounting rail, a magnetic strip is attached along which a Hall sensor that is connected to the seat rail can move. The magnetic strip, as described in U.S. Pat. No. 4,909,560, can repeatedly change its polarity along its lengthwise extension. In relative displacement along the magnetic strip, the output signal of the Hall sensor changes depending on the magnet pole. This enables incremental detection of the relative position of the vehicle seat. A position signaling device that is known from DE-101 36 820 and is based on a Hall sensor, allows the detection of two seat positions, forward and back, according to a large or small distance from the dashboard. In order to achieve a Hall sensor signal that can be evaluated and that is as significant as possible, the two publications suggest keeping the distance between the magnet poles and the surface of the Hall sensor as small as possible. In conjunction with known production and installation tolerances, this can, however, lead to the Hall sensor and its housing dragging in the relative displacement of the mounting rail and the seat rail. Aside from the unwanted noise development and the increased displacement resistance, this dragging contact can lead to damage and to failure of the sensor.

Other possible applications of position signaling device in conjunction with motor vehicles are, for example, the detection of whether the hood or trunk lid are closed and locked. Recently, passenger cars have also been provided with standardized attachment points for fixing of child safety seats. These so-called isofix systems are to enable prompt and simple attachment of a child safety seat, equipped accordingly with metal hooks, in the vehicle. Child safety seats are also known in which the seat shell can be detached from a base unit that is securely attached in the vehicle. When the seat shell is inserted again, it must be ensured that the latter is again securely connected to the base unit. In all such safety-relevant applications, it is necessary for the locking, for example of the hood, trunk lid or an attachment hook of a child safety seat to the isofix system or a seat shell on a base unit, to be reliably detected in order to notify the user of faulty locking optionally by an optical or acoustic signal.

### SUMMARY

A position signaling device is disclosed for detecting the position of two metallic or metal-coated components that can move relative to one another, comprising a magnetic field-sensitive sensor and at least one bias magnet that are spatially separated from one another and that are arranged stationary relative to one another and on two sides border a receiving gap, in which one of the two components can be moved relative to the other, the magnetic field-sensitive sensor and the bias magnet being connected to one of the two components, wherein in a vicinity of at least one of the magnetic field-sensitive sensor and the at least one bias magnet, at least one flux concentrator is arranged such that a substantially closed magnetic circuit is formed.

A vehicle seat is disclosed comprising a movable seat rail for movement relative to a mounting rail, a vehicle position signaling device connected to the mounting rail for detection of a displacement position of the vehicle seat. The positioning signaling device includes a magnetic field-sensitive sensor and at least one bias magnet that are spatially separated from one another and that are arranged stationary relative to one another and on two sides border a receiving gap, in which one of the two components can be moved relative to the other. The magnetic field-sensitive sensor and the bias magnet are connected to one of the two components. In a vicinity of at least one of the magnetic field-sensitive sensor and the at least one bias magnet, at least one flux concentrator is arranged such that a substantially closed magnetic circuit is formed. The magnetic field-sensitive sensor, the at least one bias magnet, and the flux concentrator are mounted on one of the movable seat rail and the mounting rail, and an interrogation sheet is mounted on the other of the movable seat rail and the mounting coil and projects into the receiving gap between the magnetic field-sensitive sensor and the at least one bias magnet to influence a magnetic field of the bias magnet when the vehicle seat moves.

### BRIEF DESCRIPTION OF THE DRAWINGS

Other advantages and features of the disclosure will become apparent from the following description of schematic diagrams of embodiments of the position signaling device according to the disclosure.

FIG. 1 shows a view of one section of a seat attachment with a stationary mounting rail and a seat rail that can move relative to it and an exemplary embodiment of a position signaling device that is mounted on the rail;

FIG. 2 shows a schematic section of an exemplary embodiment of the position signaling device attached to the rail system;

FIG. 3 shows a schematic diagram of the position signaling device according to FIG. 2;

FIG. 4-FIG. 6 show schematic diagrams of other exemplary embodiments of the position signaling device;

FIG. 7 shows a schematic representation of an application of an exemplary embodiment of the position signaling device as a detector of the status of a locking device; and

FIG. 8 shows a schematic diagram of the position signaling device according to FIG. 7.

### DETAILED DESCRIPTION

The disclosure relates to addressing defects of known position signaling devices. A contactless position signaling device is disclosed that can be used without major modifications for various applications, for example in order to monitor the position of two components that can move relative to one another, or the position of locks. The position signaling device can deliver a signal that can be evaluated and that is large. Contacts of the position signaling device with the component to be interrogated are to be avoided as much as possible. The position signaling device can be configured to be simple and economical in design and to allow simple installation.

An exemplary position signaling device is disclosed for detecting the position of two metallic or metal-coated components that can move relative to one another, and which includes a magnetic field-sensitive sensor and at least one bias magnet that are spatially separated from one another and that can be arranged stationary relative to one another. The magnetic field-sensitive sensor and the bias magnet on two sides border a receiving gap in which one of the two components can be moved relative to the other. The magnetic field-sensitive sensor and the bias magnet are connected to one of the two components. In the vicinity of the magnetic field-sensitive sensor and/or of at least one bias magnet, at least one flux concentrator can be arranged in such a way that a largely closed magnetic circuit is formed.

The flux concentrator focuses and concentrates the magnetic field onto the magnetic field-sensitive sensor. When the two components move relative to one another, the magnetic flux density can change more dramatically on the sensor depending on the displacement path. In this way, the operating threshold can be placed in a steeper region of the characteristic (magnetic flux density depending on the displacement path) in order to achieve more precise interrogation. The position signaling device based on the change of the magnetic flux density works like a barrier here. As a result of the concentration of the magnetic field on the magnetic field-sensitive sensor, the position signaling device can also be less sensitive to stray magnetic fields. Thus, the flux concentrator can also perform a shielding function relative to such stray pickups.

In one exemplary embodiment of the disclosure, the magnetic field-sensitive sensor can be arranged between two flux concentrators. In this way, the magnetic field of the exciter magnet can be better concentrated on the magnetic field-sensitive region of the sensor, and better resolution can be achieved. For example, a displacement path of only 0.2 mm-1 mm can be detected in this way in order to be able to position the operating threshold.

One exemplary embodiment of the position signaling device according to the disclosure calls for the bias magnet and the magnetic field-sensitive sensor to be opposite one another. This arrangement can be implemented relatively easily in mechanical terms. The receiving gap can, for example, be covered to the top. This reduces the danger that foreign bodies will travel into the receiving gap between the sensor and the bias magnet.

In the arrangement where the bias magnet and the magnetic field-sensitive sensor are opposite one another, the receiving gap that is bordered by the magnetic field-sensitive sensor and the opposite bias magnet can have a gap width of 0.2 to 50 mm. Within this region, for the gap width, relatively good status separations can be achieved with the known sensor/bias magnet pairings. The magnetic flux density of the bias magnet is, for example, roughly 5 mT to 100 mT here.

For better concentration of the magnetic field, another exemplary embodiment of the disclosure calls for the bias magnet to border a flux concentrator. The flux concentrator can be arranged on the side of the magnet facing away from the sensor for better shielding of the bias magnet.

In another exemplary embodiment of the position signaling device according to the disclosure, there are two bias magnets that are opposite the magnetic field-sensitive sensor and that border the flux concentrator on their side facing away from the sensor. The bias magnets can be arranged at a distance from one another. The flux concentrators that are provided on either side of the sensor are opposite the bias magnet in this case. The magnetic field-sensitive region of the opposite sensor can be located roughly within the interval region of the two bias magnets. This arrangement can essentially form a completely closed magnetic field circuit. The receiving gap forms an air gap between the bias magnet and the sensor. The flux concentrators that are provided on either side of the receiving gap can shield the arrangement relative to the interference fields acting from the outside.

One exemplary embodiment of the position signaling device according to the disclosure calls for at least one bias magnet to be arranged in such a way that it includes an angle of approximately (i.e., roughly) 90° with the magnetic field-sensitive sensor. Here, the sensor and the bias magnet border two sides of the receiving gap that are perpendicular to one another. This “corner variant” of the position signaling device is also mechanically simple and is suitable for applications in spatially narrowed conditions. As a result of the largely closed magnetic circuit, significant changes of the magnetic field density as a function of the displacement path can also be achieved in this corner arrangement in the relative displacement of the two components. In this way, the operating threshold of the magnetic barrier can be placed in a steeper region of the characteristic, and higher resolution of the displacement path can be achieved. The largely closed magnetic circuit also favors less sensitivity of the arrangement to stray external fields.

One exemplary embodiment of the “corner arrangement” of the position signaling device calls for the magnetic field-sensitive sensor to be pretensioned by two bias magnets that border a flux concentrator and can be arranged in such a way that they encompass an angle of approximately 90° with the magnetic field-sensitive sensor. The sensor and the bias magnets in this case border two sides of the receiving gap that are perpendicular to one another. The combination of two bias magnets with flux concentrators can lead to a still better and more controlled concentration of the magnetic field onto the sensor. In this way, stray external fields can be shielded.

The magnetic field-sensitive sensor can be configured as a galvanomagnetic sensor. Due to the ease of their use and their high output signal, useful sensors of this type are Hall sensors.

The bias magnets can be permanent magnets designed as bar magnets.

The bar magnets can be arranged recumbent relative to the magnetic field-sensitive sensor such that the flux concentrators concentrate the magnetic flux outside of each bar magnet from the north to the south pole. In the case of several bar magnets, they can be arranged such that their orientation amplifies the total intensity of the generated magnetic field.

In one exemplary embodiment of the disclosure, the flux concentrators can be flux baffles that include a magnetizable steel. Here, the sheet thickness can be roughly 0.5 mm to roughly 5 mm, or more or less.

The arrangement of the magnetic field-sensitive sensor, for example a Hall sensor, flux concentrator(s) and bias magnet(s), can be accommodated in a common housing. For example, the arrangement can be molded with plastic. The position signaling device that is present in this way as a structural unit can be mounted especially easily.

Another exemplary embodiment of the position signaling device according to the disclosure can provide shielding for the magnetic field-sensitive sensor against external interference magnetic fields. For example, the sensor can be surrounded by shielding sheets. In another exemplary embodiment of the disclosure, one of the components that can move relative to the others and on which the position signaling device is mounted, can also perform the function of this shielding against magnetic interference fields.

Due to its durability and its simple structure, the exemplary position signaling device according to the disclosure can be suitable for use in motor vehicle applications. For example, it is used for detection of the displacement position of a vehicle seat that has a movable seat rail that can be moved relative to a mounting rail that is connected to the floor of the vehicle. The magnetic field-sensitive sensor, for example, a Hall sensor, the at least one bias magnet, and the flux concentrator(s) that are accommodated, for example, as a structural unit in a common housing, can be mounted in this case on the movable seat rail or on the mounting rail. An interrogation sheet can be mounted on the respective other rail and projects into the receiving gap between the magnetic field-sensitive sensor and at least one bias magnet and influences the magnetic field of the bias magnet when the vehicle seat moves. The position signaling device or the interrogation sheet can be precisely guided in this exemplary embodiment. The position signaling device then produces a signal that can be used, for example, to control the inflation of the airbag. The position signaling device and the interrogation sheet, whose sheet thickness is always slightly smaller than the width of the receiving gap, can be arranged here on the side of the seat rail facing away from the user. In this way, they may not be unintentionally damaged by the user.

Another exemplary application of the position signaling device according to the disclosure is for detection of the locking status of a hood and/or a trunk lid of an automobile. This makes it possible to optically or acoustically indicate to the driver an open hood or trunk lid.

In another application, the position signaling device can be used to detect that a gap width, for example between the vehicle body and the hood or trunk lid, is smaller than a defined maximum value of, for example, 1 mm to 5 mm. This is intended to ensure that hands or fingers cannot be pinched in the gap, and the hood or the trunk lid can be completely closed with a large expenditure of force.

Furthermore, the position signaling device according to the disclosure can also be used for detection of the locking status of a fastening for a child safety seat to fixed attachment points, for example isofix systems, in the automobile or a seat shell of a child safety seat on a base unit mounted securely in the vehicle. Depending on the embodiment of the vehicle or of the child safety seat, the user can be notified of improper locking by a display that is provided on the dashboard or on the child safety seat.

The position signaling device designed according to the disclosure can even be used to detect the locking status of a retaining device in a child safety seat. Even in this case, for example, on the child safety seat or on the dashboard, there can be a display that lights up when the locking is improper.

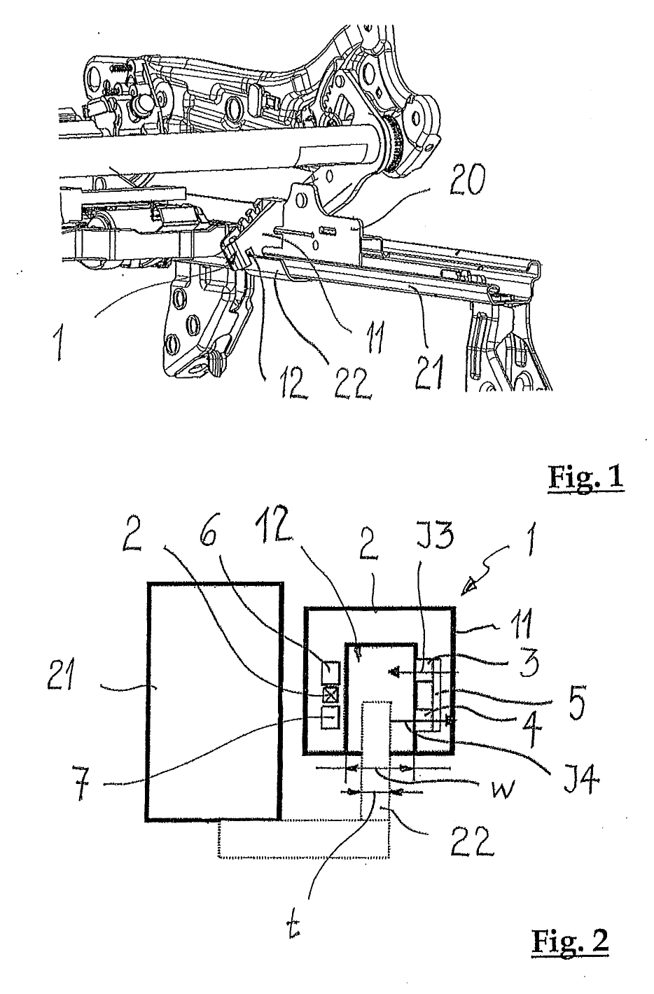

In the view of a seat attachment shown by way of example in FIG. 1 in a motor vehicle, a seat rail is referred to with the reference number 20. To adjust the vehicle seat, the seat rail 20 can be moved relative to a mounting rail 21 that is mounted securely on the vehicle floor. An exemplary position signaling device referred to with the reference number 1 as a whole is attached to the seat rail 21. The position signaling device 1 is accommodated in a housing 11 that has a slot-shaped receiving gap 12. The position signaling device overlaps the interrogation sheet 22 mounted on the mounting rail 21 that projects into the receiving gap 12. The position signaling device 1 can be used to ascertain the displacement position of the vehicle seat. Depending on the detected position of the seat, “forward” or “back” for example, the degree of inflation of the airbag can be controlled.

FIG. 2 shows a schematic diagram of the seat attachment from FIG. 1 with the exemplary position signaling device 1 shown in a cutaway view. The mounting rail in turn bears the reference number 21. The interrogation sheet mounted on the mounting rail 21 is indicated with 22. For reasons of better clarity, a representation of the seat rail that can be moved along the mounting rail 21 is omitted. All components of the position signaling device provided with the reference number 1 as a whole are accommodated in a housing 11. The interrogation sheet 22 projects into a receiving gap 12 that, for example, can have a width w of from roughly 0.2 mm to roughly 50 mm. The thickness 1 of the interrogation sheet 22 is always slightly less in each case than the width of the receiving gap 12 so that the interrogation sheet 22 can easily enter the receiving gap 12. The sheet thickness t of the interrogation sheet 12 can likewise be roughly 0.2 mm to roughly 50 mm, for the sake of simplification. The position signaling device 1 includes a magnetic field-sensitive sensor 2, in particular a Hall sensor, and a bias magnet arrangement that can include two bar-shaped permanent magnets 3, 4 according to the exemplary embodiment. The Hall sensor 2 and the permanent magnets 3, 4 are arranged opposite one another and border two sides of the receiving gap 12 that are opposite one another. As a Hall sensor, for example, a Hall sensor of the Ha15xx type from the Micronas Company or of type A 1181 from the Allegro Company can be used. The magnetic field flux density produced by the two permanent magnets 3, 4 can be approximately 5 mT to roughly 100 mT. The permanent magnets 3, 4 can be arranged in such a way that their magnetic flux densities complement and reinforce one another. The magnetization of the permanent magnets is indicated by the arrows J3 and J4. Due to the arrangement of the components of the position signaling device 1 in a common housing 11, the latter can be very easily handled and mounted. For example, the components are molded with plastic.

On either side of the Hall sensor 2 and opposite the permanent magnets 3, 4, there are flux concentrators 6, 7. The latter concentrate the magnetic field that has been produced by the permanent magnets 3, 4 onto the magnetic field-sensitive region of the Hall sensor 2. On their side facing away from the receiving gap 12, the two permanent magnets 3, 4 border another flux concentrator 5. The flux concentrators 5, 6, 7 include, for example, a magnetizable steel sheet. The arrangement of the permanent magnets 3, 4 of the flux concentrators 5, 6, 7 and of the Hall sensor 2 produces a magnetic circuit that is interrupted only by the air gap of the receiving gap 12. The flux concentrators 5, 6, 7 guide the magnetic field and concentrate it onto the Hall sensor 2. Moreover, the flux concentrators 5, 6, 7 also act as shielding relative to external interference fields. The mounting rail 21 and the seat rail that is not shown likewise act as shielding against stray external fields. The output signal of the Hall sensor 2 changes as soon as the interrogation sheet 22 travels into the action region of the magnetic circuit. As a result of the concentration of the magnetic field onto the Hall sensor, the characteristic curve is steeper (magnetic flux density compared to the relative displacement path). In this way, a greater magnetic stroke can be achieved for the same displacement path than for known position signaling device. Conversely, this can be used to resolve a smaller displacement distance for a comparably large magnetic stroke.

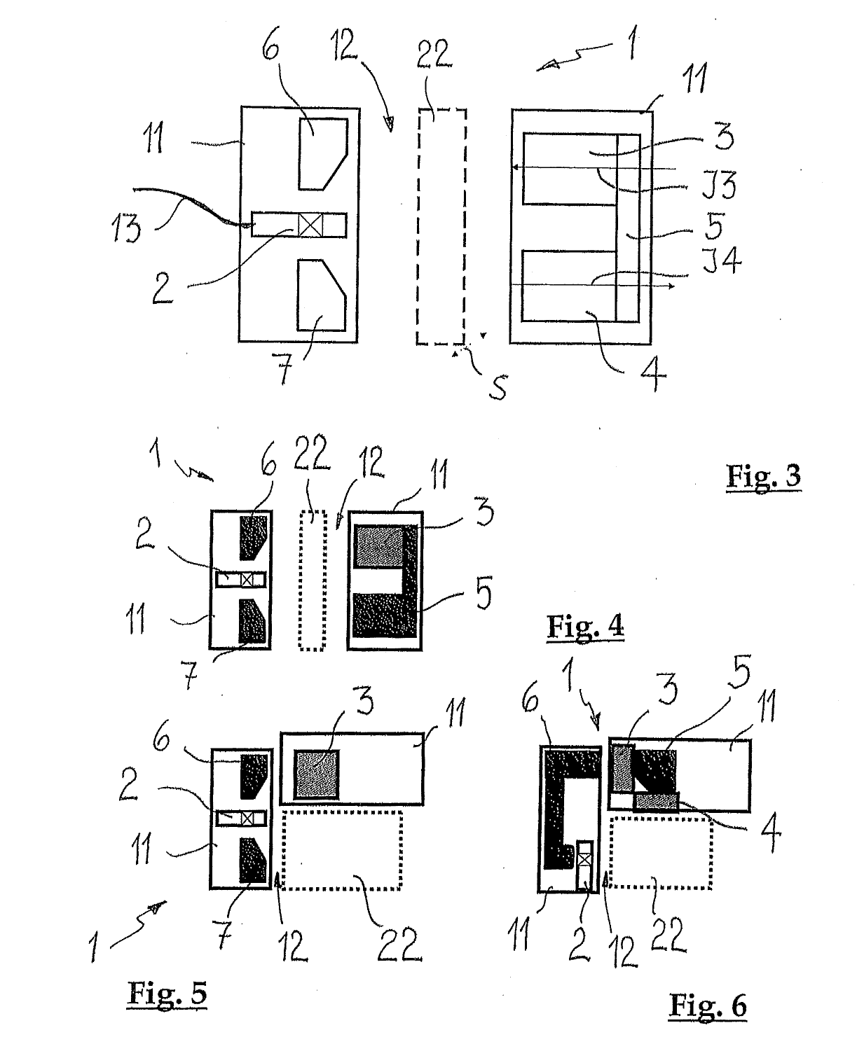

FIG. 3 schematically shows the position signaling device 1 from FIG. 2 on an enlarged scale. The housing in which the individual components are accommodated is indicated with 11. The receiving gap is in turn provided with the reference number 12. The interrogation sheet 22 is indicated by the broken line. The displacement direction is indicated by the double arrow S that device displacement out of or into the plane of the drawing. Here, either the interrogation sheet 22 or the position signaling device 1 can be displaced relative to the other stationary component. The Hall sensor bordering the two flux concentrators bears the reference number 2. The Hall sensor 2 and the two flux concentrators 6, 7 border one side of the receiving gap 12. On the opposite side of the receiving gap 12 are the two permanent magnets 3, 4 whose opposite magnetizations are indicated by the two arrows J3 and J4. With their ends facing away from the receiving gap 12, the two permanent magnets 3, 4 border the flux concentrator 5. The Hall sensor 2 is arranged in such a way that it is roughly opposite the intermediate space between the two permanent magnets 3, 4. The signals of the Hall sensor 2 are relayed to a control device via a cable 13.

FIG. 4-FIG. 6 are schematic diagrams, analogous to FIG. 3, of other exemplary embodiments of the position signaling device that is in each case provided with the reference number 1 in all figures. For better understanding of the modifications shown, the same components respectively bear the same reference numbers as in FIG. 3. In all exemplary embodiments, the components of the position signaling device 1 can be accommodated in a common housing that is indicated in each case by reference number 11.

The exemplary embodiment of the position signaling device 1 according to FIG. 4 differs from that of FIG. 3 in that only one bar-shaped permanent magnet 3 is opposite the Hall sensor 2 with the flux concentrators 6, 7. The flux concentrator 5 filled in black is made J-shaped and compensates for the absence of a second permanent magnet by its shape. The interrogation sheet 22 that can be displaced relative to the receiving gap 12 is shown by the broken line.

The exemplary embodiments of the position signaling device. which is in turn provided with the reference number 1, that are shown in FIG. 5 and FIG. 6 are corner variants. Here, the Hall sensor 2 and a bias magnet that is designed as a bar-shaped permanent magnet 3 border the two sides of the receiving gap 12 that run at right angles to one another, in which gap the interrogation sheet is indicated by the broken line at 22. Compared to the exemplary embodiment in FIG. 4, the permanent magnet 3 is shifted to a position that has been rotated by roughly 90°. The housing 11 has roughly the shape of a recumbent L. The Hall sensor 2 borders two flux concentrators 6 and 7 so that in turn, a largely closed magnetic circuit is produced.

The corner execution of the position signaling device 1 shown in FIG. 6 in turn has a housing 11 that has roughly the shape of a recumbent L. The two legs of the L-shaped housing 11 border two sides of the receiving gap 12 that run at a right angle to one another, in which gap the interrogation sheet is indicated by the broken line at 22. The Hall sensor 2 can be arranged in a (left) leg of the housing 11. A roughly C-shaped flux concentrator 6 concentrates the pretensioning magnetic field onto the magnetic field-sensitive region of the sensor 2. The magnetic field can be produced by two permanent magnets 3, 4 that are arranged in the second (right) leg of the housing 11. The arrangement of the permanent magnets 3, 4 is such that the magnetic field acting on the Hall sensor 2 is intensified. A flux concentrator 5 borders the two permanent magnets 3, 4 and concentrates the magnetic flux. Moreover, it also acts as shielding against external interference fields.

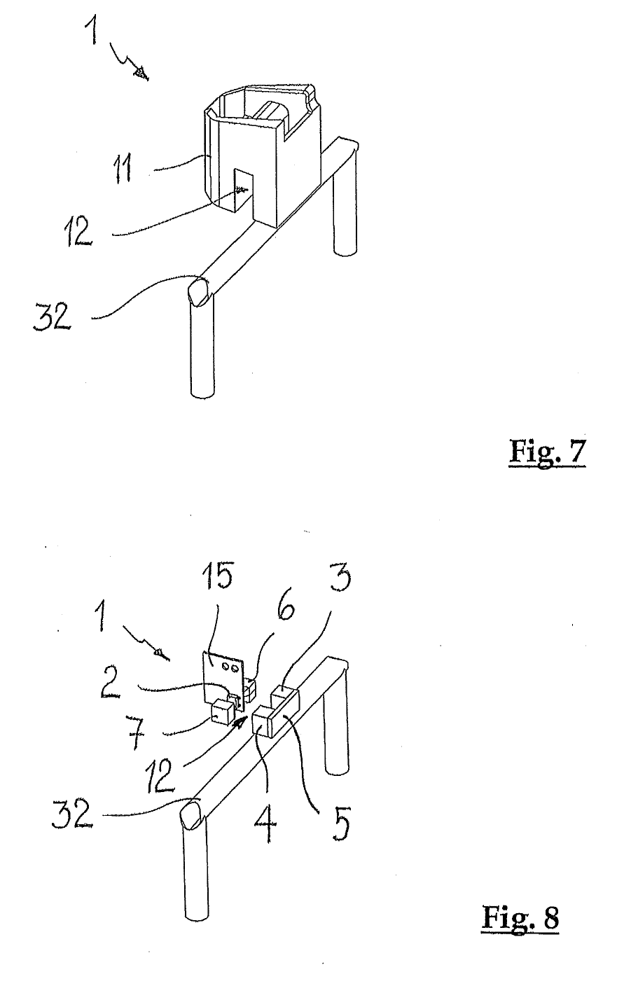

FIG. 7 schematically shows an exemplary position signaling device that, for example, can be used for the detection of the locking status of a locking device, for example of a hood lock or a trunk lid lock. The position signaling device could, however, also be used for monitoring the locking status of child safety seats at fixed attachment points in a motor vehicle, so-called isofix systems, or correct fixing of a seat shell in a base unit that is permanently mounted in the vehicle. Finally, the position signaling device could also be used in retaining systems, for example of child safety seats. The position signaling device that is provided with the reference number 1 as a whole has a housing 11 that can be equipped with a slot-shaped receiving gap 12. The slot-shaped receiving gap 12 can be designed for holding a metallic or metal-coated, clamp-shaped component 32, for example a clamp of an isofix system. During locking, the position signaling device delivers a signal that indicates to the user or the driver whether locking has taken place properly. The display can take place, for example, on the dashboard, or, in the case of a correspondingly equipped child safety seat or a removable seat shell, it can be provided directly on the child safety seat.

FIG. 8 shows the components of the position signaling device 1 from FIG. 7 that are arranged within the housing. The position signaling device 1 includes a Hall sensor 2 that is mounted on a plate 15. Flux concentrators 6, 7 for the magnetic field can be arranged on either side of the Hall sensor. The Hall sensor 2 that is mounted on the plate 15 and the flux concentrators border one side of a receiving gap 12. On the opposite side of the receiving gap 12, there are two bar-shaped permanent magnets 3, 4 arranged at a distance from one another. With their ends facing away from the receiving gap 12, the permanent magnets 3, 4 border a flux concentrator 5. This arrangement that largely corresponds to that of FIG. 3, can concentrate the magnetic field that has been produced by the permanent magnets 3, 4 onto the Hall sensor and achieves a largely closed magnetic circuit. During locking, the metallic or metal-coated clamp-shaped component 32 penetrates into the receiving gap 12. In this way, the magnetic field can be changed, and the Hall sensor 2 can generate a signal that can be used to display the locking status. For shielding against external magnetic interference fields, the Hall sensor can also be surrounded by shielding sheets that are not presented in more detail.

The disclosure is not limited to the described use and embodiments. In principle, the device according to the disclosure is suitable for all applications in which two adjacent components are moved relative to one another, and other actions are to be derived from the knowledge of the relative or absolute position.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Position signaling device for detecting a position of two metallic or metal-coated components that can move relative to one another, comprising:
a magnetic field-sensitive sensor and at least one bias magnet that are spatially separated from one another and that are arranged stationary relative to one another and on two sides border a receiving gap, in which one of the two components can be moved relative to the other, the magnetic field-sensitive sensor and the bias magnet being connected to one of the two components, wherein in a vicinity of at least one of the magnetic field-sensitive sensor and the at least one bias magnet, at least one flux concentrator is arranged such that a substantially closed magnetic circuit is formed.

2. Position signaling device according to claim 1, wherein the magnetic field-sensitive sensor is arranged between two flux concentrators.

3. Position signaling device according to claim 1, wherein the bias magnet and the magnetic field-sensitive sensor are arranged opposite one another.

4. Position signaling device according to claim 3, wherein the receiving gap that is bordered by the magnetic field-sensitive sensor and the opposite bias magnet has a gap width (w) that is 0.2 mm to 50 mm.

5. Position signaling device according to claim 3, wherein the bias magnet borders a flux concentrator.

6. Position signaling device according to claim 3, wherein two bias magnets are arranged opposite the magnetic field-sensitive sensor and border the flux concentrator on an end facing away from the sensor.

7. Position signaling device according to claim 1, wherein the at least one bias magnet is arranged such that it encompasses an angle of approximately 90° with the magnetic field-sensitive sensor, the magnetic field-sensitive sensor and the bias magnet bordering two sides of the receiving gap that are perpendicular to one another.

8. Position signaling device according to claim 1, wherein the magnetic field-sensitive sensor is pretensioned by two bias magnets that border the at least one flux concentrator and are arranged such that they include an angle of approximately 90° with the magnetic field-sensitive sensor, the magnetic field-sensitive sensor and the bias magnets bordering two sides of the receiving gap that are perpendicular to one another.

9. Position signaling device according to claim 1, wherein the magnetic field-sensitive sensor is a Hall sensor.

10. Position signaling device according to claim 1, wherein each bias magnet is a bar-shaped permanent magnet.

11. Position signaling device according to claim 10, wherein each permanent magnet is arranged recumbent relative to the magnetic field-sensitive sensor, such that the flux concentrator concentrates magnetic flux outside of the magnet from a north pole to a south pole.

12. Position signaling device according to claim 1, wherein the flux concentrator is a flux baffle of a magnetizable steel.

13. Position signaling device according to claim 1, wherein the magnetic field-sensitive sensor, flux concentrator and bias magnet, are accommodated in a common housing molded with plastic.

14. Position signaling device according to claim 1, wherein the magnetic field-sensitive sensor is surrounded by shielding against external magnetic interference fields.

15. Position signaling device according to claim 14, wherein the shielding is formed by one of the components that can move relative to another.

16. A vehicle seat comprising:
a movable seat rail for movement relative to a mounting rail;
a vehicle position signaling device connected to the mounting rail for detection of a displacement position of the vehicle seat, the positioning signaling device including:
a magnetic field-sensitive sensor and at least one bias magnet that are spatially separated from one another and that are arranged stationary relative to one another and on two sides border a receiving gap, in which one of the two components can be moved relative to the other, the magnetic field-sensitive sensor and the bias magnet being connected to one of the two components, wherein in a vicinity of at least one of the magnetic field-sensitive sensor and the at least one bias magnet, at least one flux concentrator is arranged such that a substantially closed magnetic circuit is formed, wherein
the magnetic field-sensitive sensor, the at least one bias magnet, and the flux concentrator are mounted on one of the movable seat rail and the mounting rail, and an interrogation sheet is mounted on the other of the movable seat rail and the mounting coil and projects into the receiving gap between the magnetic field-sensitive sensor and the at least one bias magnet to influence a magnetic field of the bias magnet when the vehicle seat moves.

17. Vehicle seat according to claim 16, wherein an arrangement of the sensor, bias magnet and flux concentrator is at a position of the vehicle seat that is inaccessible to a user of the vehicle, on an inside of the movable seat rail and the mounting rail.

18. Position signaling device according to claim 1, wherein one of the two components is attached to an automobile for detecting a locking status of a hood and/or a trunk lid of the automobile.

19. Position signaling device according to claim 1, wherein one of the two components is attached to an automobile for detecting a maximum gap width, between a vehicle body and a hood and/or a trunk lid prior to a final closing process.

20. Position signaling device according to claim 1, wherein one of the two components is attached to an automobile for detecting a locking status of a fastening for a child safety seat to fixed attachment points in the automobile or to a seat shell of a child safety seat on a base unit mounted in the automobile.

21. Position signaling device according to claim 1, wherein one of the two components is attached to an automobile for detecting a locking status of a retaining device in a child safety seat.
